(19) United States
(12) Patent Application Publication
(10) Pub. No.: US 2017/0203140 A1
(43) Pub. Date: Jul. 20, 2017

(54) HOOP DEVICE AND ITS USE

(71) Applicant: Rebecca HALLS, (US)

(72) Inventors: Rebecca HALLS, Los Angeles, CA (US); Stéphane GLADYSZEWSKI, Montreal (CA)

(73) Assignee: Rebecca HALLS, Los Angeles, CA (US)

(21) Appl. No.: 15/322,797

(22) PCT Filed: Jun. 30, 2015
(86) PCT No.: PCT/EP2015/064862

§ 371 Date: Dec. 29, 2016

(30) Foreign Application Priority Data
Jun. 30, 2014 (EP) 14175036.4

(51) Int. Cl. A63B 19/00; F21V 23/02; F21V 23/04; F21V 33/00

(52) U.S. Cl. CPC A63B 19/00; F21V 33/008; F21V 23/02; F21V 23/0442; A63B 2207/02

(57) ABSTRACT

The present invention refers to a hoop device comprising a tubular main body and lighting elements wherein the lighting elements are distributed on a circumference of the tubular main body and wherein some lighting elements face up and the remaining lighting elements face down. Furthermore, the tubular main body comprises a power supply unit for supplying the lighting elements with energy. In another aspect, the invention relates to a use of the hoop device characterized in that the power supply unit comprises storing means for storing energy wherein the storing means can be charged and re-charged.

The present invention refers to a hoop device comprising a tubular main body and lighting elements wherein the lighting elements are distributed on a circumference of the tubular main body and wherein some lighting elements face up and the remaining lighting elements face down. Furthermore, the tubular main body comprises a power supply unit for supplying the lighting elements with energy. In another aspect, the invention relates to a use of the hoop device characterized in that the power supply unit comprises storing means for storing energy wherein the storing means can be charged and re-charged.

Since the 1950ies, arcurate hula hoops have been used as a toy, a sports device or a training device for exercise and improving dexterity by millions of people. It is known that the hula hoop can be put around almost any rotatable part of the body, typically the waste, but also the neck, the wrist, arms or legs of the user. The spinning of the hula hoop is preferably achieved by a gyration of the rotatable part of the body, in particular the hip or the waste. In the prior art, variations of hula hoops are known which can be filled with a bubble forming liquid in order to form soap bubbles or to provide hula hoops with openings that generate sound effects when the hula hoop is rotated.

It is also known in the prior art to provide sport entertainment devices where a lighting effect is achieved by self-illuminating chemicals which is present inside the device. However, the lighting effect of the sports entertainment devices known from the prior art which is caused by a chemical reaction, fades after a certain period of time. That means that the lighting effect irrecoverably vanishes after the end of the chemical reaction. The user may than use the exhausted hula hoop without lighting effect or may re-charge the hula hoop by introducing new chemicals inside the hoop device. The use of the hula hoop without lighting effect may lead to disappointment of the user, especially if the hula hoop was thought as a gift for a child. Regarding the second alternative, i.e. re-filling the hoop device with new chemical reactands, the hoop device may be damaged by this procedure and the re-filling may involve extensive efforts. Furthermore, a repeated re-filling of fresh chemicals is problematic in terms of sustainability.

Hoop devices with lighting effects may be particularly suited for dancers, performers and choreographers who wish to incorporate one or more hula hoops into their performances. It is therefore the object of the present invention to provide a hoop device with lighting effects which does not suffer from the drawbacks and disadvantages of the hoops known from the prior art, which is suited to be used on stage at performances where the lighting effect does not vanish after a certain period of time and where this aim is achieved with little efforts and in a sustainable manner. It would additionally be appreciated by professional users if the lighting effects exceeds known lighting effects from sports devices known from the prior art which are interesting to watch for the spectators of such hoop performances.

In one aspect, the object of the present invention is solved by a hoop device comprising a tubular main body and n lighting elements characterized in that the n lighting elements are distributed on a circumference of the tubular main body, wherein a lighting elements face up and n−a lighting elements face down, n and a representing natural numbers, n>1, a≧0, and wherein the tubular main body comprises a power supply unit for supplying the lighting elements with energy.

In the context of the present invention, it is preferred that the tubular main body of the hoop device is a hollow tube which is preferably manufactured from plastic material or any other elastic material which can be processed in a way that an arcurate ring-like object in the form of a closed circuit or loop is formed. The tubular main body of the hoop device according to the present invention advantageously ensures good static properties of the hoop device and is particularly ease to handle.

It is preferred that at least two lighting elements are distributed on the circumference of the tubular main body and that one subset of the lighting elements faces up and the remaining lighting elements face down. If for example two lighting elements are distributed on the circumference of the tubular main body, it may be preferred that one of the lighting elements faces up and the other lighting elements faces down. The terms “up” and “down” refer to the plane which is spanned by the ring-like tubular main body of the hoop device.

In the context of the present invention, it is preferred to visualize virtual straight lines standing perpendicular to the plane spanned by the tubular main body of the hoop device. This virtual straight line is preferably devided into an upper and a lower part. When the hoop device is held so that the plane which is spanned by the tubular main body is parallel to the ground or the floor, the lower part of the straight lines points into the direction of the ground or the floor and the upper part of the straight lines points into the sky. It is understood that the definition of the terms “up” and “down” are changed into the contrary if the tubular main body of the hoop device is turned upside down.

It is understood that the terms “up” and “down” describe an orientation of the beam of light emitted from a lighting element of the hoop device in relation to the plane spanned from the ring-like tubular main body of the hoop device. A person with average skill in the art will know that the beams of light emitted from the lighting elements do not at all times have to be directed to the ground/floor and/or sky/ceiling, but that the beams of light may have an inclination depending on the way the hoop device is held by the user.

In the context of the present invention, the term “natural number” is used for the set of the whole numbers including 0. The hoop device of the present invention comprises at least two lighting elements so that the total number n of lighting elements is >1. It is preferred that a subset of the lighting elements with a members faces upwards, i.e. the light emitted from these a lighting elements points into the direction of the sky or the ceiling if the hoop device according to the present invention is used insight a building.

In the context of the present invention, it is preferred that the remaining lighting elements, which do not face upwards, face downwards. The number of these remaining lighting elements can be calculated by subtracting the number a of the lighting elements facing down from the total number n of lighting elements arranged on the circumference of the tubular main body of the hoop device according to the present invention, i.e. the number of lighting elements facing down can be specified as n−a. a can be any total number including 0. If, for example, a=0, it is preferred that all n lighting elements of the hoop device according to the present invention point into the same direction. If, e.g., a>0, a group of a lighting elements preferably face up and a remaining group of n−a lighting elements face down.

The tubular main body of the hoop device according to the present invention comprises a power supply unit for supplying the lighting elements with energy. In the context of the present invention, it is preferred that the lighting elements are supplied with electrical energy. It is preferred that the power supply unit comprises storing means for the electrical energy and connecting means, for example cables and connectors, for connecting the power supply unit with an energy source. It is preferred that the storing means for storing the energy are part of the tubular main body of the hoop device and it is particularly preferred that the storing means are arranged inside the hollow ring-like tubular main body forming the hoop device.

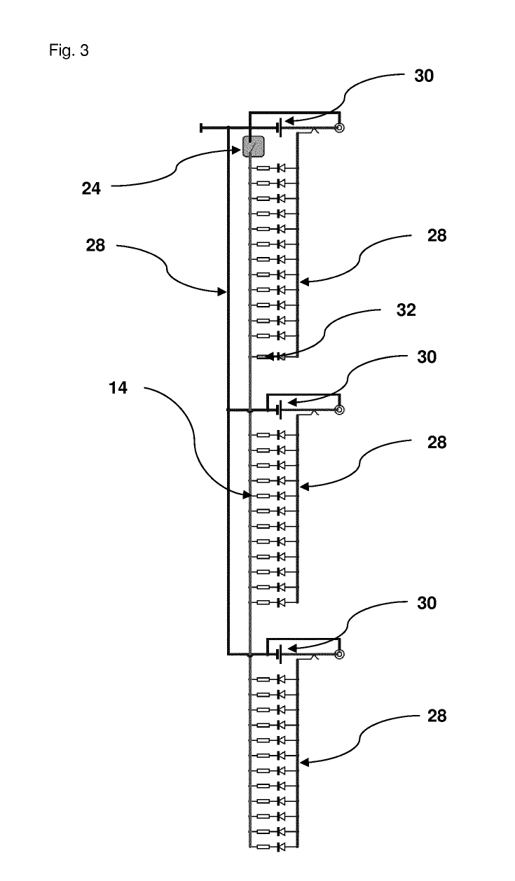

In the context of the present invention, it is preferred that the storing means may be selected from a group preferably comprising accumulators and/or batteries. A person skilled in the art will know which further storing means can be used in the context of the present invention. Preferably, the storing means are connected via an electrical circuit with the lighting elements. An example of an electrical circuit of a preferred embodiment of the invention can be found in FIG. 3. Advantageously, the connecting means for connecting the storing means and the lighting elements are arranged in the hollow inside of the tubular main body of the hoop device so that they may not be seen from the audience and that they not interfere with a user of the hoop device. It is also preferred that the storing means can be connected with an external energy source, for example an electrical power outlet or an electrical socket.

The opportunity to connect the storing means to an external energy source is particularly helpful when accumulators are used as storing means. If accumulators are used as storing means in the context of the present invention, a sustainable way of re-charging the storing mean of the power supply unit of the hoop device according to the present invention is provided. It was totally surprising that a hoop device with lighting elements can be provided that comprises an internal power supply unit which can be charged by means of an external energy source over and over again so that the hoop device according to the present invention can be used by a professional dancer, choreographer or dancer at a great number of performances without any limitations of the functionality of the lighting effects created by the lighting elements of the hoop device according to the present invention. It also came as a surprise that the hoop device can be provided so that electrical connecting means do not hamper the use of the hoop device as the inventors present a preferred arrangement of the electrical elements of the electrical circuit which is arranged completely in the interior of the tubular main body of the hoop device. Thus, no interfering and/or dangling connecting means are present when using the hoop device which is particularly advantageous as dangling connecting means might generate a source of danger for the user of the hoop device.

In a further preferred embodiment of the invention, the natural number n is an even number and/or a=½·n. This preferred embodiment of the invention is particularly suited when a very harmonic, homogenous optical impression of the lighting effect generated by the hoop device is to be achieved. If the natural number n is even and a represents ½ of n, it is preferred that the same number of lighting elements is facing up and the other half of the lighting elements faces down. In the context of the present invention, it may be preferred that different patterns of lighting effects may be achieved by the up and down facing arrangement of the lighting elements on the circumference of the tubular main body.

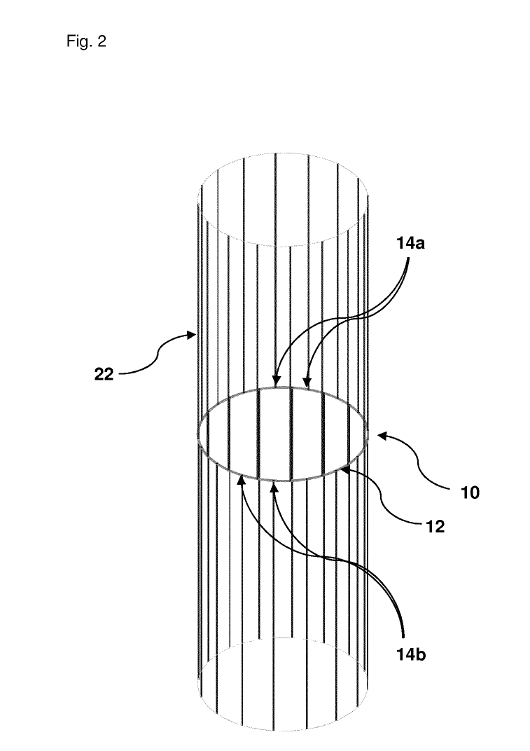

In one particular embodiment of the invention, it may be preferred that the lighting elements face up and down alternately. This means that lighting element A faces upwards, lighting element B faces downward, lighting element C faces upwards, lighting element D faces downwards and so on. This preferred arrangement of lighting elements has shown to create particularly impressive lighting effects when the hoop device is used by a dancer and/or performer on stage. In particular, the preferred arrangement according to this embodiment of the present invention interacts surprisingly effectfully with artificial fog which sometimes is used on stages as well as the optical effect of a performance is surprisingly enhanced. An example of this particular is shown in FIG. 2.

For other applications, it may be preferred that other arrangements of the lighting elements may be used. For example, the half of the lighting elements facing upwards may be arranged on one arcurate half of the tubular main body, whereas the remaining half of the lighting elements facing downwards is arranged on the remaining half circle of the tubular main body. It is understood that these alternative arrangements are covered by the present invention as well.

In a further preferred embodiment of the invention the n lighting elements are regularly distributed on the circumference of the tubular main body comprising an angle distance α of α=360°/n. In this preferred embodiment of the invention, the lighting elements comprise equal distances between each other. It is preferred that the lighting elements are distributed on the circumference of the tubular main body equidistantly. In the context of the present invention, it is preferred that this equidistance between the lighting elements refers to both the angle distance α measured in degrees and to the absolute distance between two lighting elements measured in millimeters. It is preferred that the angle distance between two lighting elements is determined by virtually connecting each lighting element with the central point of the circular tubular main body of the hoop device and determining the angle at the central point of the circular main tubular main body which is enclosed by these two legs. Because of the preferred regular distribution of the n lighting elements on the circumference of the tubular main body of the hoop device, the angle distance α can be determined by dividing 360° representing the full circle by the number n of the lighting elements. Tests have shown that the preferred regular distribution of the lighting elements has a particularly positive effect on spectators as it creates a particularly harmonic optical effect on stage and harmonizes particularly well with additional lighting installations which may be used for the performance.

In the context of the present invention, the distance between two lighting elements is the length of the direct straight line connecting the two lighting elements in question. For other purposes, it may also be preferred to determine the arcurate distance between two lighting elements which preferably does not correspond to the shortest distance between the lighting elements, but refers to the distance between the two lighting elements in question on the circumference of the tubular main body. It is understood that the arcurate distance between two lighting elements is greater than the direct distance between two lighting elements. It is preferred in the context of the embodiment of the invention where the lighting elements are regularly distributed on the circumference of the tubular main body that both the distance and the arcurate distance between two lighting elements is equal. For example, the distance between two lighting elements may be in a preferred range of 60 to 90 mm, in a more preferred range of 70 to 80 mm and most preferred 75 mm.

In a further preferred embodiment of the invention, the power supply unit is preferably formed from 1 to 5, more preferably from 2 to 4 and most preferably formed from 3 accumulators. In this particular embodiment of the invention, it is preferred that the storing means of the power supply unit are formed from accumulators. In the context of the present invention, an accumulator preferably represents an apparatus by means of which energy can be stored. In the context of the present invention, it is preferred to use electrical accumulators, particularly rechargeable accumulators. Tests have shown that Li-Batteries with U=3.6 V and Q=840 mAh are particularly suited for the use in the hoop device according to the present invention. It is preferred to charge the accumulators by an USB-charging device which may be connected to an external energy source, thus supplying the accumulators with electrical energy. Preferably, the external energy source may be an electrical power outlet such as a wall socket. It is preferred that a 3 h charging time enables a use of the hoop device according to the present invention of 1.5 h. A USB-charger of the type RD 084 DY 002 has shown to be particularly suited in the context of the present invention.

It is preferred that the accumulators are regularly distributed on the circumference of the tubular main body of the hoop device. Tests have shown that the regular distribution of the accumulators on the circumference of the tubular main body leads to a very stable energy supply of the lighting elements. Preferably, the power supply unit is designed so that each accumulator supplies the same number of lighting elements with electrical energy. In the context of the present invention, this means that each storing device, for example an accumulator, feeds the same number of lighting elements with energy. For example, when 36 lighting elements are distributed on the circumference of the tubular main body and three accumulators are used, each accumulator supplies 12 lighting elements with electrical energy.

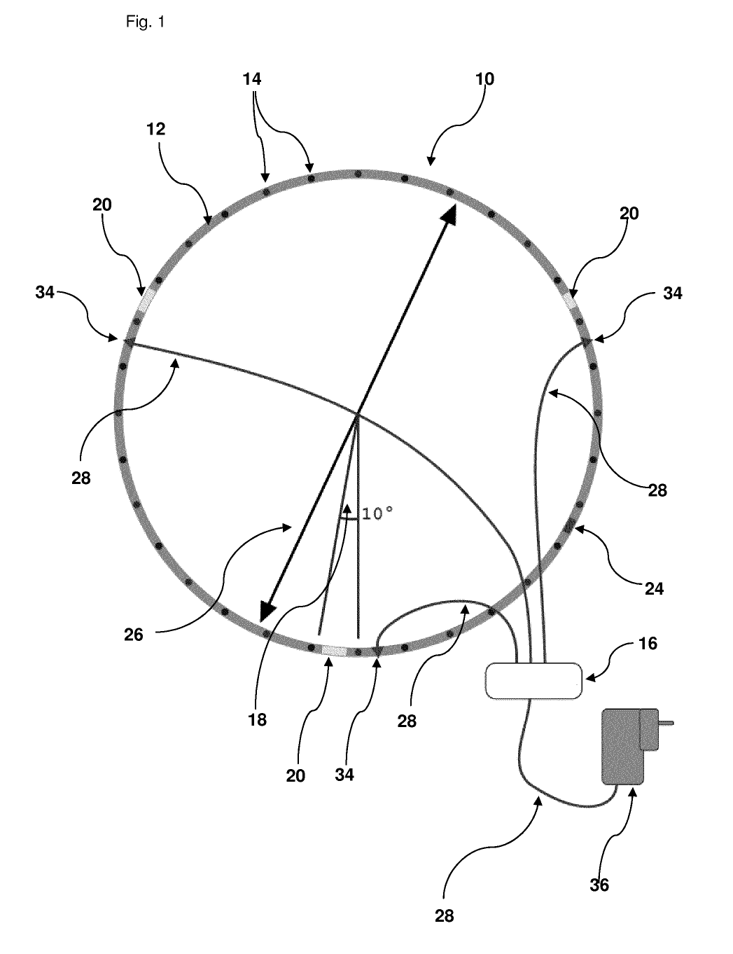

It is preferred to provide inlet means in the tubular main body of the hoop device according to the present invention where the electrical energy from the external energy source forwarded by the USB-charging device is introduced into the tubular main body and transferred with connecting means to the storing device, in particular the accumulator(s) inside the hollow tubular main body of the hoop device. Preferably, the accumulators forming the power supply unit are arranged between two adjacent lighting elements. A preferred arrangement of lighting elements, inlet means and accumulators can be seen in FIG. 1, 4 or 5.

Tests have shown that a preferred number of three accumulators lead to surprisingly long time period in which the hoop device according to the present invention may be used. It came as a surprise that this particular number of accumulators lead to a prolonged using time for the hoop device.

In a further preferred embodiment of the invention the lighting elements emit laser light with a wave length in visible range of 300 to 800 nm. In this particular embodiment of the invention, the lighting elements are preferably formed by laser sources with a preferred diameter of 6 mm and a preferred length of 10 mm. In the context of the present invention, a laser source is a device that emits light through a process of optical amplification based on the stimulated emission of electromagnetic radiation. A person skilled in the art will know that laser sources are available emitting laser light within a very large range of different wave lengths. In the context of the present invention, it is preferred to use laser sources as lighting elements which emit light with wave lengths in the visible range of 300 to 800 nm as surprising lighting effects can thus be achieved when the hoop device is used on a stage. In the context of the present invention, it is preferred to refer to those wave lengths which can be recognized by the human eye in connection with the human brain as “visible range of wave lengths”. A person with average skill in the art will know that this visible range of wave lengths will be 300 to 800 nm.

Tests have shown that in particular laser sources with a preferred working current of smaller than 40 mA, a preferred input power of approximately 150 mW and a preferred working temperature in a range of −36 to 65° Celsius are particularly suited to be used in the hoop device according to the present invention. It is preferred in the context of the present invention to connect the preferred laser sources used as lighting elements in the hoop device parallel with each other.

The preferred use of laser sources emitting light with a wave length in the visible range enables the viewer of a hoop performance to recognize the laser light emitted by the lighting elements and to enjoy the lighting effects caused by the visible laser light. Advantageously, the visible laser light interacts particularly impressively with artificial fog and additional lighting elements which may be uses on a stage where hoop performances are carried out. Preferably, the lighting elements used in the context of the present invention have an output laser power of <5 mW. This is particularly advantageous as lighting elements with an output laser power of <5 mW are less harmful for e.g. human eyes when hit by a laser beam.

In a further preferred embodiment of the invention, the lighting elements emit laser light with one single wave length or different wave lengths. In the context of the present invention it may be preferred that the n lighting elements which are arranged within the tubular main body of the hoop device according to the present invention, emit laser light with different wave lengths. It is a well-known fact that different wave lengths in the visible range correspond to different colors of the laser light emitted by the lighting elements. By emitting different wave length, lighting effects with different colors are created by the use of the hoop device according to the present embodiment of the invention. This gives advantageously way to a surprisingly great variety of choreographies which may be thought of taking in consideration of the present invention. For other purposes, it may also be preferred to use lighting elements emitting laser light with one single wave length. This will lead to the emission of laser light in one single color.

In a further preferred embodiment of the invention, the a lighting elements facing up emit light with a first wave length and the n−a lighting elements facing down emit light with second wave length. In this particular embodiment of the invention, it is preferred that the lighting elements facing upwards emit light with one color and that the remaining n−a lighting elements which face downwards, emit light in a second color. This most preferred embodiment of the invention has shown to create the most impressive optical lighting effects in combination with artificial fog on the stage and in the interplay with light and darkness in the performance room. Surprisingly, this embodiment of the invention has shown also very well suited for outdoor performances.

In a particularly preferred embodiment of the invention, the first wave length is in a range of 420 to 490 nm and the second wave length is in a range of 650 to 750 nm. It is preferred that the first wave length corresponds to blue laser light and the second wave length in a range of 650 to 750 nm refers to red laser light. With regard to the second wave length, it is most preferred to use laser sources as lighting elements emitting light in a wave length of 650 nm. It is once more noted that the definition of the terms “downwards” and “upwards” may change as soon as the hoop device according to the present invention is turned around. In the context of the present invention, the terms “up” and “down” are used to express that laser beams are preferably emitted by lighting elements in opposite directions wherein the opposite laser beams preferably enclose a virtual angle of 180° and stand perpendicularly on a plane spanned from the circular tubular main body of the hoop device according to the present invention. In preferred embodiments of the present invention, it may be preferred that the lighting elements facing up and down are arranged alternately on the circumference of the tubular main body of the hoop device, that the lighting elements facing upwards represent one haft of the lighting elements and the lighting elements facing downwards represent the remaining half of the lighting elements and/or that the lighting elements facing upwards emit laser light in a first wave length and the remaining n−a lighting elements facing downward emit light. These wave lengths may for example correspond to red and blue laser light in preferred ranges of 420 to 490 nm (blue) and 650 to 750 nm (red).

In a further preferred embodiment of the invention, the tubular main body comprises at least one switch for switching on and off the lighting elements. Providing the hoop device with at least one switch for switching on and off the lighting elements is particularly suited for hoop devices which are used in professional hoop performances in which surprising and non-expected performance effects shall be carried out. It may be particularly effective to start a performance in the dark with the lighting elements of the hoop device initially switched off. When for example music sets in, the lighting elements can be switched on by the use of the switch device. It may particularly be advantageous to switch on and switch off the lighting elements depending on the surrounding circumstances in the performance room, for example light or darkness, sound, artificial fog and so on.

In a further preferred embodiment of the invention, the switch is a magnetic switch. Magnetic switches have shown to be particularly suited in the context of the present invention as they can be integrated surprisingly easily into the interior of the hollow tubular main body of the hoop device so that only a very small part of the magnetic switch is present on the outside of the tubular main body. It is preferred that the switching on and switching off is carried out with this preferred switch device by pushing or touching the switch device. Furthermore, tests have shown that a very light touch of the preferably magnetic switch device is sufficient to achieve the switching on or off of the lighting element.

In the context of the present invention, it is preferred that an IR marker is positioned in the vicinity of the switch device so that the switch can easily be found by the performer and/or dancer when operation the hoop device. The use of an IR marker has shown to be particularly helpful when the hoop device is operated in darkness or, more preferred, with little light so that the IR marker can help to indicate the position of the switch device which is preferably integrated into the tubular main body of the hoop device according to the present invention.

In a further preferred embodiment of the invention, the tubular main body has an inner diameter in a preferred range of 800 to 900 mm and a more preferred inner diameter of 840 mm. Tests have shown that the given dimensions lead to a particularly comfortable and soft engagement of the hoop device according to the present invention with the user. This is particularly advantageous when the hoop device is used by professional dancers and/or performers who spend many hours per day operating the hoop device. For these users, it is preferred that excessive demands of the parts of their bodies which are exposed to the physical contact with the hoop device may significantly be reduced. This is surprisingly achieved by the tubular main body with an inner diameter in a preferred range of 800 to 900 mm, most preferred with an inner diameter of 840 mm.

The tubular main body with an preferred inner diameter of 840 mm has shown to be particularly suited for the integration of lighting elements as this inner diameter leads to preferred distances of the lighting elements that interacts surprisingly well with the dimensions of the preferred energy storing devices of the power supply unit. Thus, a very simple and robust electrical circuit can be integrated into the hollow interior of the tubular main body of the hoop device. In particular, the given dimensions of the tubular main body are not chosen arbitrarily, but take into account the dimension of the additional elements of the hoop device according to the present invention. Therefore, the present invention can be regarded as a combination of different elements that interact synergistically. In particular, the combination of the elements according to the present invention exceeds the sum of the single effects of the single elements, thus forming a synergistic system representing the hoop device according to the present invention.

Another advantage of the preferred inner diameter of 840 mm of the tubular main body is the simplified use of the hoop device with the given diameter which is particularly advantageous when the hoop device is used by professional users for whom the hoop device preferably represents their working daily life work equipment. The preferred inner diameter of 840 mm has therefor been elaborated by the inventors out of their comprehensive daily experiences with hoop devices.

In a further preferred embodiment of the invention, the tubular main body is formed from a tube
having an outer diameter in a preferred range of 15 to 23 mm, in a more preferred range of 17 to 21 mm and a most preferred outer diameter of 19 mm and/or
having an inner diameter in a preferred range of 13 to 18 mm, in a more preferred range of 15 to 16 mm and a most preferred inner diameter of 15.5 mm.

Tubular main bodies with a preferred outer diameter in a range of 15 to 23 mm enable for particularly robust embodiments of the present invention which may be advantageous when used by users with reduced motoric abilities, such, as for example, children. Hoop devices with the given preferred outer diameter range may surprisingly be easy to grip and handle and show an enhanced robustness and stability against mechanical deformation. A hoop device with a preferred small outer diameter lead to an embodiment of the present invention where material consume and costs can significantly be reduced compared to prior art hula hoops.

Hoop devices with a preferred outer diameter in the range of 17 to 21 mm are particularly easy to process by existing machinery and/or plants. Hoop devices having a most preferred outer diameter of 19 mm have shown to advantageously combine robustness and stability, but are cost-efficient and material-saving to produce and allow for an easy handling which is preferred when using the hoop device according to the present invention in a professional surrounding. Tests have shown that the most preferred outer diameter of 19 mm corresponds surprisingly well to a preferred inner diameter of 15.5 mm leading to the above-mentioned advantages.

In a further preferred embodiment of the invention, the tubular main body comprises a preferred number of 28 to 44 lighting elements, a more preferred number of 32 to 40 lighting elements and most preferred 36 lighting elements. These preferred numbers of lighting elements are the result of the technical experience of the inventors. It was totally surprising that a hoop device with a preferred number of 36 lighting elements can be provided wherein the lighting elements can securely be supplied with electrical energy wherein the connecting means for transferring the electrical energy can be integrated into the hollow interior of the tubular main body of the hoop device and where storing means as part of a power supply unit can be integrated into the interior of the tubular main body which provide sufficient energy for even long-term performances using the hoop device according to the present invention. It is understood that embodiments using 28 to 44 lighting elements or other related ranges of numbers of lighting elements are also covered by the present invention. It is noted that embodiments of the present invention using different numbers of lighting elements which result from a further development of laser sources as preferred lighting elements which lead to smaller or larger laser sources and alternative numbers of lighting elements are also covered by the present invention.

A preferred number of 36 lighting elements is particularly advantageous because a regular distribution of said 36 lighting elements on the circumference of the tubular main body can be carried out very easily, resulting in a preferred angle distance of 10° between two lighting elements. This preferred angle distance of 10° interacts surprisingly well with the dimensions of the additional elements of the hoop device according to the present invention, i.e. the energy storing devices, the switch and/or the inlet for the USB-charging device which may preferably be integrated into the tubular main body of the hoop device.

In a further aspect, the present invention refers to the use of a hoop device as described above, comprising the following steps:
a) providing a hoop device,
b) charging at least one accumulator of the power supply unit by connecting the power supply unit to an energy source so that the hoop device is charged,
c) de-connecting the power supply unit of the hoop device from the energy source,
d) operating the hoop device, wherein light is emitted by the lighting elements and the at least one accumulator is discharged,

wherein steps b) to d) can be repeated.

This use of a hoop device is particularly advantageous when at least one accumulator is used as a storing device of the power supply unit of the hoop device. It may be preferred that the at least one accumulator is formed from a rechargeable battery, for example a Li-Battery with U=3.6 V and Q=840 mAh. Preferably the at least one accumulator may be charged by connecting the power supply unit to an external energy source, such as for example a wall socket. An average person skilled in the art will know further external energy sources to which the power supply unit may be connected. By the connection of the power supply unit to an external energy source, it is preferred that the at least one accumulator of the power supply unit is charged, i.e. the contents of the accumulator are modified so that they are able to deliver electrical energy to electrical consumers.

It is preferred to de-connect the power supply unit from the energy source when the charging process is completed. For some applications, it may be preferred that the de-connecting of the power supply unit may take place even though the charging process has not been completed. As an example, a charging process of preferably 3 h may lead to a using time of the hoop device according to the present invention auf 1.5 h.

It is understood that the steps b to d can be repeated, i.e. the hoop device according to the present invention can advantageously be re-charged and operated over and over again. It was totally surprising that a hoop device can be provided with a power supply unit which enables re-charging storing means, for example accumulators, so that the hoop device can be used in sustainable way without dangling connecting means, such as electric cables, which would dramatically disturb the use of the hoop device and destroy the optical impression which is desired when using a hoop device according to the present invention.

In the context of the present invention, the term “operation the hoop device” refers to rotating the hoop device around any part of the human body which is suited for carrying out rotating movement. In the context of the present invention, it is also preferred that any use of the hoop device, let it be any movement, dancing performance or any conceivable way of use is referred to as “operation of the hoop device”. In most cases, the operation of the hoop device is preferably combined with the emission of light by the lighting elements.

In one preferred embodiment of the present invention, the emission of light can be started and/or stopped by the use of a switch device. The at least one accumulator of the power supply unit is discharged by the operation of the hoop device as electrical energy is consumed by the lighting elements for the emission of light, preferably laser light, with one single or different wave length corresponding to one single or different colors.

In a further preferred embodiment of the invention, the emission of light by the lighting elements is switched on or switched off by a switch. In the context of the present invention, this means that while operation the hoop device, the lighting elements can be switched on or switched off by the use of a switched device so that light does not necessarily have to be emitted during the whole operation of the hoop device, that can advantageously be adapted to surrounding circumstances, such as music, light and/or darkness or the present or absence of artificial fog on the stage. The ability to switching on and off the lighting elements is particularly advantageous as the dis-charging of the energy storing means, for example the accumulators, can be controlled by the use of the switch. It was totally surprising that a hoop device can be provided where the emission of light can be stopped and/or started during the operation of the hoop device. It came as a surprise that the handling and the operation of a hoop device, especially in a professional dancing and/or performance environment, can be enabled and simplified by the hoop device according to the present invention. Up to now, the person skilled in the art had thought that it is not possible to provide a hoop device with lighting elements where the emission of light can be switched on or off which is still easy to handle and to use in a professional dancing and/or performance manner.

The invention will be described by the following figures:

FIG. 1: View of a preferred embodiment of the invention

FIG. 2: View of the hoop device (10) emitting laser beams (22) upwards and downwards

FIG. 3: Schematic view of an exemplary electrical circuit of the invention

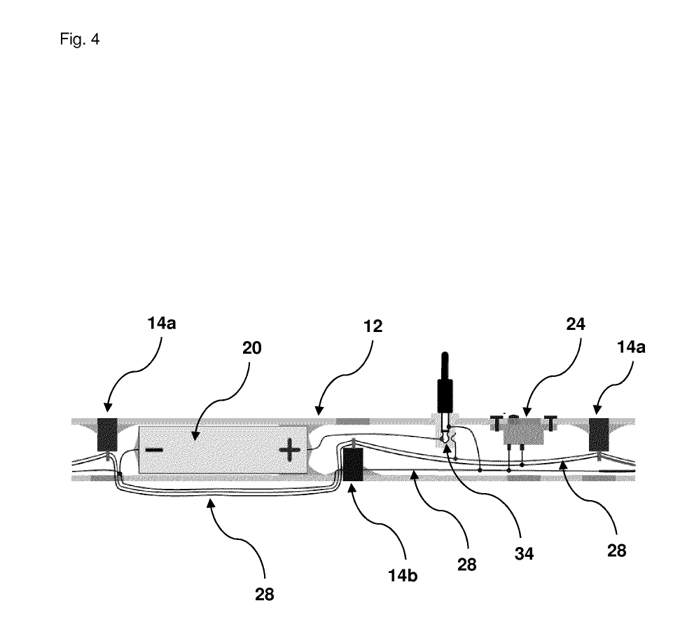

FIG. 4: View of a section of a preferred embodiment of the invention

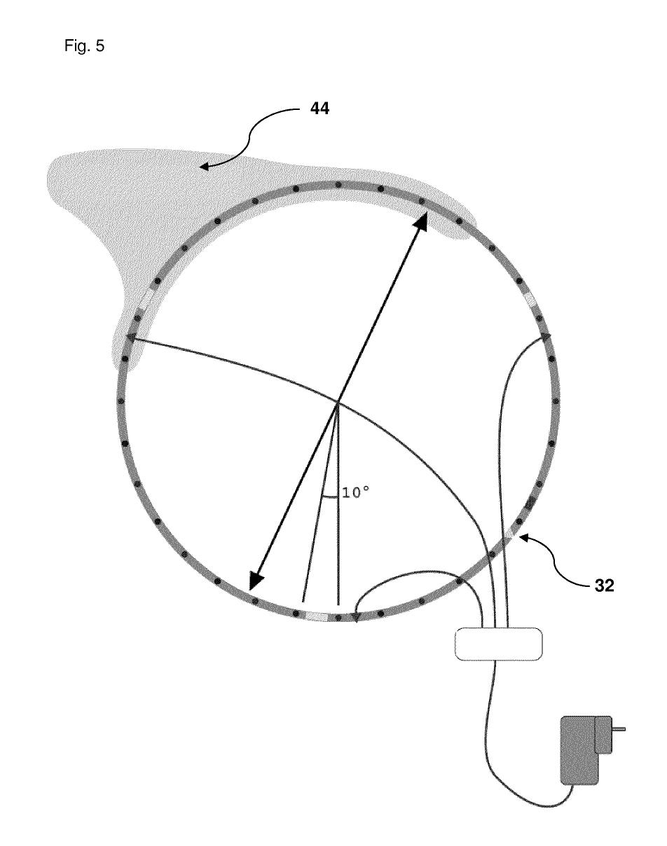

FIG. 5: View of a preferred embodiment of the invention

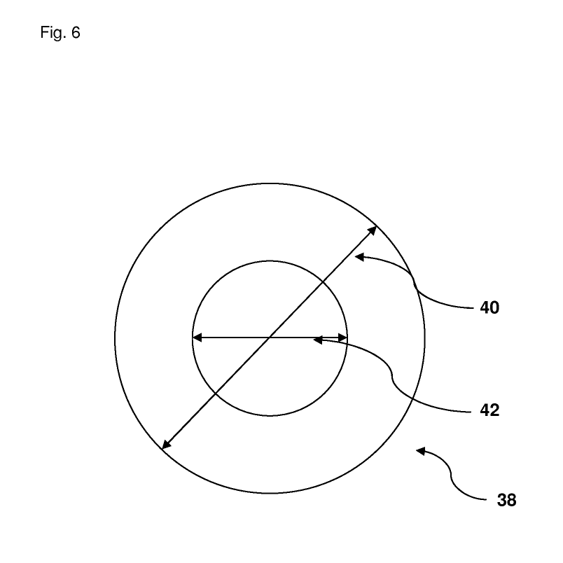

FIG. 6: Schematic view of the tube (38) forming the tubular main body (12)

FIG. 1 shows a preferred embodiment of the hoop device (10) according to the present invention. The ring-like tubular main body (12) forming the hoop device (10) is shown in which the lighting elements (14) are incorporated. In the preferred embodiment of the invention in FIG. 1, the hoop device (10) comprises 36 lighting elements (14) wherein 18 lighting elements face upwards (14 a) and 18 lighting elements face downward (14 b). In the shown preferred embodiment of the invention, the lighting elements facing upwards (14 a) and the lighting elements facing downwards (14 b) are arranged alternately on the circumference of the tubular main body (12). In the preferred embodiment according to FIG. 1, the angle distance α (18) between two adjacent lighting elements (14) is 10°. The inner diameter (26) of the tubular main body (12) is illustrated by the arrow with the two tips. In this preferred embodiment of the invention, the inner diameter (26) of the tubular main body (12) is 840 mm. FIG. 1 also shows the power supply unit (16) which is connected by electrical connecting means (28) to a connector device (36) for connecting the power supply unit (16) to an external energy source. Furthermore, the power supply unit (16) is connected by the electrical connecting means (28) to inlet devices (34) for the electrical energy which are incorporated into the tubular main body (12). The electrical connecting means (28) may, for example, be cables.

The tubular main body (12) is preferably formed from a hollow plastic tube (38). Within the hollow interior of the tubular main body (12), the inlet devices for the electrical energy (34) are connected by electrical connecting means (28) to energy storing means (20). In the preferred embodiment shown in FIG. 1, there are three energy storing means (20) which are distributed regularly on the circumference of the tubular main body (12) of the hoop device (10). Preferably, the energy storing means can be formed from accumulators (30) with a voltage U=3.6 V.

The preferred embodiment of the invention shown in FIG. 1 comprises a switch (24) which is integrated into the tubular main body (12) of the hoop device (10). This switch (24) can preferably be used for switching on or switching off the lighting elements (14) and thus starting and/or stopping the emission of laser light (22) by the lighting elements (14).

FIG. 2 shows a preferred embodiment of the hoop device (10) according to the present invention. The tubular main body (12) is shown comprising a number of lighting elements (14). In the preferred embodiment shown in FIG. 2, the hoop device (10) comprises 36 lighting elements (14). In the example of the present invention shown in FIG. 2, 18 lighting elements (14 a) emit laser light (22) upwards. In the context of the present invention, this means that the laser light (22) is emitted perpendicularly to a virtual plane (not shown) spanned by the tubular main body (12) of the hoop device (10). The term “facing upwards” preferably describes a perpendicular relation between the laser light (22) emitted from the lighting elements (14 a) facing upwards to the virtual plane formed from the tubular main body (12), as a right angle (90°) is preferably enclosed by the laser beams (22) emitted by the lighting elements (14 a) which face upwards and the virtual plane. In the preferred embodiment shown in FIG. 2, the remaining 18 lighting elements (14 b) emit laser light (22) downwards. These laser beams (22) stand perpendicularly on the virtual plane formed from the tubular main body (12). The laser beams emitted from the lighting elements (14 a) facing upwards and the lighting elements (14 b) facing downwards enclose an angle of 180° with each other and point into opposite directions. It is understood that the hoop device (10) can be turned around so that the lighting elements (14 b) which previously emitted laser light (22) downwards then send out laser light (22) in an upwards direction.

FIG. 3 shows an electrical circuit of a preferred embodiment of the present invention. Shown in FIG. 3 are the lighting elements (14) which are connected by electrical connecting means (28) which may preferably be formed by cables. The exemplary electrical circuit comprises three voltage sources, i.e. energy storing means (20) which are formed in the preferred embodiment shown in FIG. 3 by accumulators (30) with a voltage of U=3.6 V. FIG. 3 also shows the arrangement of a switch (24) which is integrated into the exemplary electrical circuit. Furthermore, an IR marker (32) is shown in FIG. 3 with R_{IR}_{_}_{LED}=100 R.

FIG. 4 shows a section of a preferred embodiment of the hoop device (10) according to the present invention. FIG. 4 shows a tubular main body (12) comprising a hollow interior. The tubular main body (12) shown in FIG. 4 comprises two lighting elements (14) facing upwards. Additionally, a lighting element (14 b) facing downwards is shown in the middle of FIG. 4. FIG. 4 also shows an energy storing means (20) which may for example be formed from an accumulator (30). The components of the electrical circuit are connected to each other by electrical connecting means (28) which can preferably be formed from cables.

The section of the preferred embodiment of the invention shown in FIG. 4 also comprises a switch (24) for switching on or off the lighting elements (14) which is also integrated into the electrical circuit in the interior of the tubular main body (12) of the hoop device (10) according to the present invention. Furthermore, an inlet device (34) for introducing the electrical energy into the electrical circuit is shown in FIG. 4. The inlet device (34) represents the female connector which may receive a male connector device which than can be connected to the power supply unit (16) by electrical connecting means (28). In FIG. 4, the male connector device is present in the female inlet device (34) which is preferably integrated and part of the tubular main body (12) of the hoop device (10).

FIG. 5 shows a preferred embodiment of the invention with three accumulators (30) as energy storing means (20). In the preferred embodiment shown in FIG. 5, the three accumulators (30) are distributed regularly on the circumference of the tubular main body (12) of the hoop device (10). In the context of the present invention, a regular distribution of components preferably means that these components have equal angle distances. In the present example of the invention shown in FIG. 5, the angle distance between the three accumulators is 120°. Thus, each accumulator (30) feeds twelve lighting elements (14) with electrical energy. In the preferred embodiment shown in FIG. 5, the lighting elements (14) are formed from laser sources. FIG. 5 also shows an IR marker (32) with R_{IR}_{_}_{LED}=100 R.

FIG. 6 shows a sectional view of the tube (38) forming the tubular main body (12). The tube (38) has an outer diameter (40) and an inner diameter (42). Central in the tube (38) forming the tubular main body (12) of the hoop device (10) is the hollow interior in which most of the electrical components of the present invention are preferably integrated.

### LIST OF REFERENCE SIGNS

10 hoop device
12 tubular main body
14 lighting elements
14 a lighting elements facing up
14 b lighting elements facing down
16 power supply unit
18 angle distance α
20 energy storing means
22 laser light
24 switch
26 inner diameter of tubular main body (12)
28 electrical connecting means, for example cables
30 accumulator with U=3.6 V
32 IR marker with R_{IR}_{_}_{LED}=100 R
34 inlet device for electrical energy
36 connector device to external energy source
38 tube
40 outer diameter of tube (38)
42 inner diameter of tube (38)

1. Hoop device (10) comprising a tubular main body (12) and n lighting elements (14)
characterized in that
the n lighting elements (14) are distributed on a circumference of the tubular main body (12), wherein a lighting elements (14a) face up and n−a lighting elements (14b) face down, n and a representing natural numbers, n>1, n≧0 and wherein the tubular main body (12) comprises a power supply unit (16) for supplying the lighting elements (14) with energy.

2. Hoop device (10) according to claim 1
characterized in that
n is an even number and a=½·n.

3. Hoop device (10) according to claim 1 and/or 2
characterized in that
the n lighting elements (14) are regularly distributed on the circumference of the tubular main body (12) comprising an angle distance (18) α of α=360°/n.

4. Hoop device (10) according to one or more of the preceding claims
characterized in that
the lighting elements (14) face up and down alternately.

5. Hoop device (10) according to one or more of the preceding claims
characterized in that
the power supply unit (16) is preferably formed from 1 to 5, more preferably from 2 to 4 and most preferably formed from 3 accumulators (30).

6. Hoop device (10) according to one or more of the preceding claims
characterized in that
the lighting elements (14) emit laser light (22) with a wave length in a visible range of 300 to 800 nm.

7. Hoop device (10) according to one or more of the preceding claims
characterized in that
the lighting elements (14) emit laser light (22) with one single wave length or different wave lengths.

8. Hoop device (10) according to one or more of the preceding claims
characterized in that
the a lighting elements (14a) facing up emit light with a first wave length and the n-a lighting elements (14b) facing down emit light with a second wave length.

9. Hoop device (10) according to one or more of the preceding claims
characterized in that
the tubular main body (12) comprises at least one switch (24) for switching on and off the lighting elements (14).

10. Hoop device (10) according to claim 9
characterized in that
the switch (24) is a magnetic switch.

11. Hoop device (10) according to one or more of the preceding claims
characterized in that
the tubular main body (12) has an inner diameter (26) in a preferred range of 800 to 900 mm and a more preferred inner diameter (26) of 840 mm.

12. Hoop device (10) according to one or more of the preceding claims
characterized in that
the tubular main body (12) is formed from a tube (38)
having an outer diameter (40) in a preferred range of 15 to 23 mm, in a more preferred range of 17 to 21 mm and a most preferred outer diameter (40) of 19 mm and/or
having an inner diameter (42) in a preferred range of 13 to 18 mm, in a more preferred range of 15 to 16 mm and a most preferred inner diameter (42) of 15.5 mm.

13. Hoop device (10) according to one or more of the preceding claims
characterized in that
the tubular main body (12) comprises a preferred number of 28 to 44 lighting elements (14), a more preferred number of 32 to 40 lighting elements (14) and most preferred 36 lighting elements (14).

14. Use of a hoop device (10) according to one or more of the preceding claims
comprising the following steps
a) providing a hoop device (10),
b) charging at least one accumulator (30) of the power supply unit (16) by connecting the power supply unit (16) to an energy source so that the hoop device (10) is charged,
c) de-connecting the power supply unit (16) of the hoop device (10) from the energy source,
d) operating the hoop device (10), wherein light (22) is emitted by the lighting elements (14) and the at least one accumulator (30) is discharged,
wherein steps b) to d) can be repeated.

15. Use of the hoop device (10) according to claim 14
characterized in that
the emission of light (22) by the lighting elements (14) is switched on or off by a switch (24).
